(19) United States
(12) Patent Application Publication
(10) Pub. No.: US 2025/0354014 A1
(43) Pub. Date: Nov. 20, 2025

(54) COATING COMPOUNDS, PROCESSES FOR MANUFACTURING COATING COMPOUNDS, AND COATINGS MADE FROM THE COATING COMPOUND

(71) Applicant: Neyra Industries Inc., Cincinnati, OH (US)

(72) Inventor: Eric Berget, Sharonville, OH (US)

(21) Appl. No.: 19/210,101

(22) Filed: May 16, 2025

Related U.S. Application Data
(60) Provisional application No. 63/649,832, filed on May 20, 2024.

(51) Int. Cl. C09D 5/02; C08K 3/26; C08K 3/34; C09D 7/20; C09D 7/61; C09D 7/80; C09D 133/04

(52) U.S. Cl. CPC C09D 5/022; C09D 5/028; C09D 7/20; C09D 7/61; C09D 7/80; C09D 133/04; C08K 2003/265; C08K 3/346; C08K 2201/014

(57) ABSTRACT

A coating compound for use as a sport surface includes a mixture of liquid vehicle of water, a latex, and glycol ether EPH, and particles of kaolin. The compound include particles of calcium carbonate, an organic acid, and a clay mineral. The clay may be one or more of palygorskite, montmorillonite, and smectite. A process for manufacturing a coating compound includes mixing a liquid vehicle in a first mixture including glycol ether EPH. The process includes mixing a second mixture including particles of kaolin, latex, and a portion of the first mixture. The process may include mixing a third mixture including particles of a clay mineral and another portion of the liquid vehicle. A coating includes particles of kaolin and at least one other particle. The particles being bonded together on the base with a continuous between particles in which the continuous phase includes an acrylic polymer.

### CROSS REFERENCE TO RELATED APPLICATION

This application claims priority to U.S. Provisional App. No. 63/649,832 filed on May 20, 2024, which is incorporated by reference herein in its entirety.

### FIELD OF THE INVENTION

Embodiments of the invention relate to coating compounds, processes for producing coating compounds, and coatings formed from the compound, particularly for use as sport and related surfaces.

### BACKGROUND

The formation of durable coatings on exterior surfaces poses numerous challenges, particularly those on which sports and the like are played. Exterior surface coatings are exposed to natural elements during application and during use. At each of these times, weather negatively affects the utility of the coating. In that regard, during formation of the coating rain, the sun, and other adverse weather conditions can, if not properly ameliorated, negatively impact the formation of the coating. For example, the durability of a coating formed under adverse weather conditions may be reduced so that the coating cannot withstand use. Also, because some coatings are continuously exposed to weather, these coatings may gradually degrade with time. To address weather, particularly during application, steps, such as accelerated curing with dryers may be implemented. However, the additional steps often increase the expense of installation. Similarly, coatings may be modified to enhance their weatherability. However, any single one of these modifications may also be prohibitively expensive.

As an example of one coating composition, an acrylic composition can wet applied by pouring the composition on an underlaying surface and using a squeegee to spread the composition along the surface to produce a uniformly thick coating. As another application technique, the coating composition may be sprayed on the underlaying surface. These coatings may be colored.

While coating compositions for surfaces, such as sport surfaces, are known, there remains a need for improved coatings which address one or more problems. In this regard, the present invention seeks to provide a process for manufacturing coating compounds, coating compounds, and coatings formed from those compounds which address one or more of the problems in the industry.

### SUMMARY

The present invention overcomes the shortcomings and drawbacks of coating compounds, methods of making those compounds, and applied coatings for use on athletic surfaces. While the invention will be described in connection with certain embodiments, it will be understood that the invention is not limited to those embodiments. On the contrary, the invention includes all alternatives, modifications and equivalents as may be included within the spirit and scope of the present invention. In one aspect of the invention, there is a coating compound for application on a base surface for use as a sport surface. In one embodiment, the coating compound includes a mixture of liquid vehicle comprising water, a latex, and glycol ether EPH, and particles of kaolin.

In one embodiment, the coating compound further includes particles of calcium carbonate.

In one embodiment, the liquid vehicle further includes an organic acid. In that regard, in an exemplary embodiment, the organic acid is acetic acid.

In one embodiment, the coating compound includes a clay mineral.

In one embodiment, the clay mineral includes one clay mineral or a combination of two or more clay minerals selected from palygorskite, montmorillonite, and smectite. In an exemplary embodiment, the clay mineral is palygorskite.

In one embodiment, all non-aqueous components of the coating compound are present in an amount from 30 wt. % to 60 wt. %.

In one aspect of the invention, there is a process for manufacturing a coating compound for application to a base surface. The process includes mixing at least a portion of a liquid vehicle in a first mixture. The first mixture includes glycol ether EPH. The process further includes mixing a second mixture including particles of kaolin, latex, and a portion of the first mixture. The process further includes mixing a third mixture including particles of a clay mineral and another portion of the liquid vehicle. The process further includes mixing the second mixture with the third mixture whereby the coating compound is formed.

In one embodiment, mixing the third mixture includes mixing another portion of the first mixture.

In one embodiment, mixing the at least a portion of the liquid vehicle includes adding a ethylene glycol to the first mixture.

In one embodiment, mixing the third mixture includes mixing an organic acid.

In one embodiment, mixing the organic acid includes mixing acetic acid.

In one embodiment, mixing the third mixture includes mixing one clay mineral or a combination of two or more clay minerals selected from palygorskite, montmorillonite, and smectite.

In one embodiment, mixing the third mixture includes mixing palygorskite.

In one embodiment, nonaqueous components of the coating compound are present in an amount from 30 wt. % to 60 wt. % of the coating compound.

In one aspect of the invention, there is a coating on a base on which a sport is to be played. The coating includes a plurality of particles including particles of kaolin and at least one other particle. The particles being bonded together on the base with a continuous or nearly continuous phase between adjacent particles in which the continuous or nearly continuous phase includes an acrylic polymer.

In one embodiment, the at least one other particle is a clay mineral. In an exemplary embodiment, the clay mineral includes one clay mineral or a combination of two or more clay minerals selected from palygorskite, montmorillonite, and smectite.

In one embodiment, the continuous phase or nearly continuous phase further includes acetic acid.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a flow diagram illustrating one embodiment of the invention.

FIG. 2 is a schematic cross-sectional view of a coating formed according to one embodiment of the invention.

FIG. 3A is a photograph of an interior of a let-down tank according to one embodiment.

FIGS. 3B and 3C are photographs of interiors of a dispersion blade mixer and baffle system, respectively according to one embodiment.

FIG. 4A is a photograph of a slurry of montmorillonite according to one embodiment.

FIG. 4B is a photograph of a portion of a grind solution containing a slurry palygorskite according to one embodiment.

FIG. 5A is a photograph of a portion of a grind solution containing palygorskite according to one embodiment.

FIG. 5B is a photograph of the portion of grind solution of FIG. 5A.

FIG. 5C is a photograph of coagulation of latex and glycol ether EPH.

FIG. 6 is a photograph of a C-solution according to one embodiment.

FIG. 7A is a photograph of comparative coating following testing.

FIGS. 7B and 7C are photographs of coatings according to embodiments of the invention following testing.

FIG. 8 is a collection of photographs of various coatings according to one or more embodiments of the invention.

FIG. 9A is a photograph of a comparative coating.

FIG. 9B is a photograph of a coating according to one embodiment of the invention.

FIG. 10 is a photograph of coatings according to one embodiment of the invention.

### DETAILED DESCRIPTION

Embodiments of the invention are directed to processes for manufacturing a coating compound, to coatings made from that coating compound, and to methods of applying a coating compound. The exemplary coatings are for use as sport surfaces, such as tennis courts, outdoor basketball courts, and pickleball courts. The coating cosmetically enhances the sport surface, which is typically an asphalt or a concrete base. The coating has enhanced durability to wear (e.g., foot traffic) and weather over time relative to existing sport surfaces. Further, during application, the coating compounds are advantageous in that they broaden the range of applicable conditions under which the coating compound may be applied to a base surface. In general, the exemplary coating compounds include a mixture a liquid vehicle including selected ones of a modified polyelectrolyte polymer, a latex, an organic acid, and one or more organic additives and a plurality of particulates including all or selected ones of a clay and a filler.

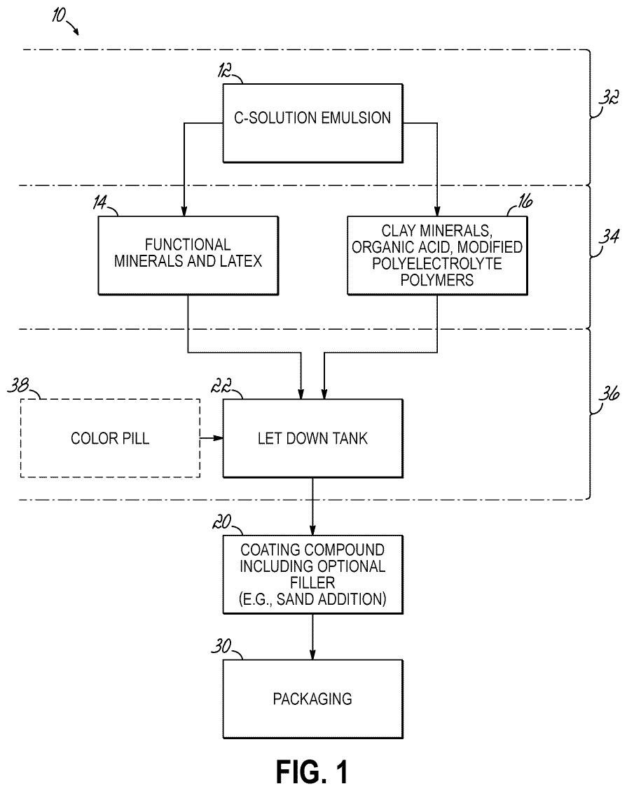

In one embodiment, the mixture of all or selected ones of the compounds above is produced by a multi-part mixing process 10 in which selected ones of the components are separately mixed in at least one premixture. Once a mixture is initially prepared, only then are additional mixtures prepared. For example, and with reference to FIG. 1, a mixture 12 may be initially and separately prepared. This mixture may be referred to as a C-solution herein. Two separate mixtures 14 and 16 may then be subsequently prepared. One or both those mixtures 14 and 16 may incorporate the C-solution 12 during or following their preparation. Each mixture 12, 14, 16 may contain a unique combination of compounds. In other words, the mixtures 12, 14, 16 are not the same. In the process of FIG. 1, the mixtures 12, 14, 16 are mixed in a specific order by which a coating compound 20 is formed. It is believed that the mixtures 12, 14, 16 and the timing of their combination reduces the chemical demand for any single one of the added components. In other words, less of any particular component may be required. In addition, mixing according to embodiments prevents deleterious premature chemical reactions from occurring, such as preventing flash coagulation with a latex, which may inadvertently consume selected components thereby inhibiting their intended function. The staged mixing thereby imbues the coating compound 20 with improved properties, both in terms of application of the coating compound 20 and durability of a coating formed from the coating compound 20. The enhancement in the characteristics of the coating compound 20 is at least partly related to the process by which the coating compound 20 is made.

In an exemplary embodiment in which there are three mixtures 12, 14, and 16, as shown in FIG. 1, the process 10 includes three stages of mixing. In a first stage of mixing 32, the C-solution 12 is prepared. The C-solution 12 includes a mixture of organic additives by which an emulsion is formed. In a second stage 34, the C-solution 12 may be mixed into two separately prepared mixtures 14 and 16 as they are prepared. Each of mixtures 14 and 16 may be referred to as grind phases herein. One grind phase14 includes a filler and latex in addition to the C-solution 12. Another grind phase 16 includes minerals, organic acid, and a polymer in addition to the C-solution 12. The two mixtures 14 and 16 each of which includes the C-solution 12 are then mixed with one another in a third stage of mixing 36 to form a single homogeneous coating compound 20, such as in a let-down tank 22. Thus, the process 10 includes a plurality of mixtures which are combined and mixed in at least three stages. By contrast, embodiments of the process 10 do not include adding all compounds initially into a single tank or vessel and mixing. Further, embodiments of the process do not include adding each compound serially to a single tank or vessel and mixing as each is added. Rather, stated in another way, embodiments of the invention include grouping selected compounds and mixing those compounds as a group to form two or more intermediate homogenous compounds prior to combining the intermediate compounds together.

In one exemplary embodiment, the groups of compounds are selected to keep the viscosity of each of the mixtures 12, 14, and 16 to a minimum, such as a viscosity near that of water. Further, mixing according to embodiments may facilitate shear thinning of any predetermined group of compounds, for example, the mixtures including clay minerals. When the components, including the C-solution 12, are combined to form the mixtures 14 and 16, each has a minimum viscosity. Subsequently, when the mixtures 14 and 16 are combined and mixed, the viscosity may increase as the coating compound 20 is formed. For example, the viscosity may increase to that of the coating compound 20. By way of example, the viscosity of the coating compound may be in a range of 115 KU to 128 KU. The low viscosity condition of the grind phases 14 and 16 following their mixing may persist for a limited time, for example, for 10 to 35 minutes after being combined in the let-down tank 22. By controlling the rheology throughout the mixing stages, it is believed that the components are more homogenously mixed prior to a viscosity increase to that of coating compound 20. Stated another way, controlling the rheology permits turbulent flow mixing (as compared to plug/laminar flow mixing). Further, a sequence of component addition and/or control of the pH of the mixture is believed to enhance a capability of the coating compound 20 for suspending the particles found in the mixture and any particles added following formation of the coating compound 20. For example, additional sand remains dispersed in suspension in the coating compound 20. Thus, the fillers in the coating compound 20 do not settle or take significantly longer to settle under gravity. This is advantageous, because the particulates of the coating compound 20 and, optionally sand, for example, remain dispersed throughout the coating compound 20 prior to application and during storage. In the absence of segregation, when applied to a base surface then, the homogeneity of the coating compound 20 eliminates pour marks. The as-poured coating and the coating after drying are aesthetically superior to single step coating mixtures.

More specifically with respect to viscosity of the mixtures, at a time following initial combination, the viscosity of the combined mixture in the let-down tank 22 may increase. The length of time that low viscosity is maintained in the let-down tank 22 may depend on the pH of the mixture of the grind phases 14 and 16. In one embodiment, the pH of one or both grind phases 14, 16, 22 may be adjusted, such as by addition of an effective amount of ammonia solution (concentration of 4%). After this initial low-viscosity period in the let-down tank 22, the viscosity of the mixture will start to increase from that of water to within a range of 115 KU to 128 KU. By way of further example, the viscosity may be in a range of 120 KU to 125 KU within an hour following combination of the grind phases 14 and 16. Following increase of the viscosity, mixing of the combined grind phases 14 and 16 may continue for an additional hour to ensure consistency and remove any remaining gases. Not being bound by theory, maintaining a minimum of viscosity during selected stages (e.g., first stage 32, second stage 34, and initial portion of the third stage 36) and mixing compounds while maintaining a minimum of viscosity during those stages facilitates production of a homogeneous compound at each stage. Mixing compounds at low viscosity may also facilitate release of any air entrainment in the mixture, specifically during initial mixing in the third stage 36. Thus, each compound in each mixture is most efficiently distributed in the mixture.

With continued reference FIG. 1, the coating compound 20 includes a solids phase consisting of each of the particles of filler and the particles of clay suspended in a liquid vehicle consisting of at least latex, organic acid, and ethylene glycol. Per FIG. 1, the coating compound 20 is packaged at 30. In an alternative embodiment, sand or similar may be mixed into the coating compound 20, such as in or following the let-down tank 22. While FIG. 1 indicates that sand may be mixed prior to packaging at 30, sand may be mixed following packaging 30 and prior to application of the compound on the sport surface.

As a further, alternative, exemplary embodiment, C-solution 12 is added to the grind phase 14, but the C-solution 12 forms no part of the other grind phase 16. That is, the grind phase 16 includes only the minerals, acid, and polymers. There may be a preference for addition of the C-solution 12 to the mineral fillers and latex-containing mixture 14. Even so, the C-solution 12 may be added to the grind phase 16 and form no portion of the grind phase 14. So, while embodiments are disclosed in which at least a portion of the C-solution 12 is added to each of the grind phases 14 and 16, mixing the C-solution 12 during mixing of each grind phase 14 and 16 may not be required. In this embodiment then, the third stage of mixing 36 includes mixing the grind phase 16 (e.g., lacking the C-solution 12) and the grind phase 14 in the let-down tank 22 to form the coating compound 20.

In the exemplary embodiment, the C-solution 12 is prepared by mixing a plurality of organic additives and is a stable emulsion. In one embodiment, the C-solution 12 is prepare by mixing a modified organopolysiloxane, such as Foam a Tac 220 (defoamer)(available from Enterprise Specialty Products, Inc.); a sodium polyacrylate [Poly(sodium prop-2-enoate)], such as KemEcal 4011 (dispersant)(available from Kemira Water Solutions Canada, Inc.); 2-Phenoxyethanol, such as glycol ether EPH, available from Dow Materials (coalescent); a nonylphenol ethoxylate, such as Superwet 9.5 (wetting agent), available from Superior Oil Company, Inc. of Indianapolis, Indiana (also available from Dow Materials under a different tradename); and ethylene glycol (humectant). Alternative terms to 2-Phenoxyethanol with CAS Registry number 122-99-6 include Ethylene glycol monophenyl ether, PHE, PHE-G, PHE-S, PhG, and Phenylglycol. Utilizing the C-solution 12 is believed avoid negative effects, which would otherwise occur, when glycol ether EPH is mixed with latex. An exemplary compound of the C-solution 12 follows in Table 1.

TABLE 1

| Component | Wt. % range |
|---|---|
| Ethylene Glycol | 28-50 |
| Glycol Ether EPH | 35-70 |
| Superwet 9.5 | 0.1-10 |
| Foam A Tac 220 | 0.1-3 |
| KemECal 4011 | 0.1-6.5 |

In the exemplary embodiment, the grind phase 14, which may be referred to as a “first grind phase” or a “latex-containing phase,” is prepared by mixing a powder of an inorganic filler and a latex. The quantity of the inorganic filler is not particularly limiting and may depend on the surface for which the coating compound 20 is to be applied. As an example, all components excluding water may range from 30 wt. % to 60 wt. % of the coating compound 20. As the weight percent of the components excluding water increases the coating compound 20 is believed to cost more. As a further example, all components excluding water may range from 40 wt. % to 45 wt. % of the coating compound 20. In the exemplary embodiment, the liquid vehicle includes the latex, which is selected from acrylic emulsions. The acrylic emulsion is selected from those emulsions not sensitive to mechanical shear and must perform well with high filler and pigment loading. One exemplary acrylic emulsion usable in the coating compound 20 is EPS 2708, available from Engineered Polymer Solutions. The latex may range from 10 wt. % to 36 wt. % of the coating compound 20. Another exemplary acrylic emulsion, i.e., latex, usable alone or in combination with EPS 2708 is RayCryl 61 available from Engineered Polymer Solutions. RayCryl 61 is an example of a high-solids acrylic emulsion polymer. The latex may range from 10 wt. % to 36 wt. % of the coating compound 20. A minimal amount, such as 10 wt. % of latex, is believed to provide a minimal bonding of the particulates in the coating. Amounts below 10 wt. %, while usable, may result in a coating that lacks sufficient durability. Yet another exemplary acrylic emulsion usable alone or in combination with EPS 2708 and/or in combination with any of the other acrylic emulsions disclosed herein is EPS 2789 available from Engineered Polymer Solutions. EPS 2789 is an example of a high-solids acrylic emulsion polymer. The latex may range from 10 wt. % to 36 wt. % of the coating compound 20. And yet another exemplary acrylic emulsion usable alone or in combination with the EPS 2708 and/or with any of the other acrylic emulsions disclosed herein is EPS 297-97 available from Engineered Polymer Solutions. EPS 297-97 is an example of a high-solids acrylic emulsion polymer. The latex may range from 10 wt. % to 36 wt. % of the coating compound 20.

In one embodiment, the inorganic filler is calcium carbonate powder. While any calcium carbonate powder may be usable, calcium carbonate powder may be selected based on particle size and/or based on the particle aspect ratio. Particle size may be referred to as coarse or as fine and those in between coarse and fine. For example, as a fine particle size, the filler may have an average particle size of 3 pm. As further example, as a coarse particle size, the filler may have an average particle size of between 30 μm and 44 pm. And, as yet another example, as a particle size in between fine and coarse particle sizes, the mineral filler may have an average particle size in the range of 10 μm to 13 pm. Particle aspect ratio of the calcium carbonate particles may be in the range of 1 to 2. In an exemplary embodiment, an average particle aspect ratio may be 1.3. Mixtures of any combination or all three particle size distributions and various aspect ratios are contemplated and may be beneficial during application of the coating compound 20 and for the durability of the coating.

Another exemplary inorganic filler is kaolin, also referred to as china clay, which may be included in addition to the calcium carbonate. Kaolin in powder form may be present in a minimal amount sufficient to produce a smooth coating. By way of example, kaolin is present in an amount from 3 wt. % to 7 wt. % in the coating compound 20. An average particle size of kaolin powder may be from 1 μm to 2 μm with a specific surface area of 15 m²/g. The aspect ratio of kaolin particulates may be in the range of 3 to 18. In an exemplary embodiment, the aspect ratio of kaolin particulates may be 8.4. The platy nature of the kaolin particles is believed to reduce the roughness and increase the opacity of a coating relative to a coating without kaolin. This function of the kaolin particles may be due, at least in part, to how the plate-like particle configuration settles after the coating compound is applied to a surface.

An exemplary compound of the grind phase 14 follows in Tables 2A and 2B.

TABLE 2A

| Component | Wt. % |
|---|---|
| EPS ®2708 (50 wt. % water) | 42.85 |
| Kaolin 1-2 μm at 15 m²/g | 6.56 |
| Calcium Carbonate (3 μm) | 8.27 |
| Calcium Carbonate (10-13 μm) | 8.93 |
| Calcium Carbonate (x < 44 μm) | 6.89 |
| C-solution 12 | 6.81 |
| Water (this is extra, so may be added as needed) | 19.69 |

TABLE 2B

| Component | Wt. % |
|---|---|
| RayCryl 61 (60 wt. % water) | 40.37 |
| Kaolin 1-2 μm at 15 m²/g | 7.22 |
| Calcium Carbonate (3 μm) | 9.11 |
| Calcium Carbonate (10-13 μm) | 17.43 |
| C-solution 12 | 7.51 |
| Water (this is extra, so may be added as needed) | 18.35 |

Continuing the exemplary embodiment, the second mixture 16, which may be referred to as a “second grind phase” or a “acid-containing” portion is prepared by mixing a clay mineral, an organic acid, and a polyelectrolyte polymer. In embodiments of the invention, the clay mineral includes one clay mineral or a combination of two or more clay minerals selected from palygorskite, montmorillonite, and smectite. It is noted that attapulgite clays are a composite of smectite and palygorskite. While kaolin may be added to the second mixture 16, in this exemplary embodiment, the second mixture 16 excludes kaolin, which is found in the first grind phase 14. The clay mineral may be present in an amount from a minimal amount (i.e., 0.5 wt. %) to 5 wt. % in the coating compound 20. The clay mineral is present in powder form and may have a particle size distribution with an average particle size in the range of 10 μm to 40 μm. The aspect ratio of the clay mineral particulates may be in the range of 15 to 50. In one embodiment, the average aspect ratio of the clay mineral particulates is 32.5. In the exemplary embodiment, the clay mineral is palygorskite with an average particle size of 13 μm and particulate aspect ratios in the range of 15 to 50.

In embodiments of the invention, the organic acid is a weak organic acid, for example, acetic acid and is present in an amount from 0.5 wt. % to 1 wt. % of the coating compound 20 when the concentration of the acetic acid is 5% up to 10%. As an example, where acetic acid of 5% is used, the coating compound 20 may contain 0.7 to 0.9 wt. % acetic acid. Because acetic acid is a carboxylic acid, it can interact with other ingredients, for example, by hydrogen bonding with other additives. One such example is the combination of acetic acid and ethylene glycol to form a eutectic solvent combination. It has been noted that acetic acid at low dosages can be beneficial to drying under temperature extremes. However, high dosages in excess of 1 wt. % can cause severe cracking in the film. While a specific mechanism by which acetic acid acts in the combination is unknown, it is believed that an excessive amount (e.g., greater than 1 wt. % of coating compound 20 at 5% concentration) alters the particle size distribution of the calcium carbonate particles such that the resulting coating becomes prone to cracking. In the exemplary embodiment, the organic acid is acetic acid. In exemplary embodiments, the coating compounds of the invention including acetic acid have an aroma consistent of acetic acid.

In embodiments of the invention, the polyelectrolyte polymer is a modified polyelectrolyte polymer, such as hydroxyl ethyl cellulose (HEC) with a glyoxal coating. An exemplary HEC with glyoxal coating is available from Ashland and is sold under the trademark Natrasol™. Either Natrosol™ HHBR or HHR are usable in accordance with embodiments of the invention. The polyelectolyte polymer is present in an amount from 0.1 wt. % to 2 wt. % of the coating compound 20. By way of specific example, the coating compound 20 may include 0.84 wt. % HEC.

An exemplary compound of the second mixture 16 follows in Tables 3A and 3B.

TABLE 3A

| Component | Wt. % (wet) |
|---|---|
| Modified hydroxyl ethyl cellulose | 4.97 |
| Palygorskite | 8.52 |
| Acetic acid | 5.34 |
| C-solution 12 | 6.24 |
| Water | 74.92 |

TABLE 3B

| Component | Wt. % (wet) |
|---|---|
| Modified hydroxyl ethyl cellulose | 4.40 |
| Palygorskite | 7.33 |
| Acetic acid | 4.39 |
| C-solution 12 | 6.45 |
| Water | 77.43 |

A summary of the usable ranges for the inorganic filler and clay minerals as a percentage of the solids content in the coating compound without sand (described below) is tabulated in Table 4 below. In one embodiment, the non-aqueous content of the coating compound 20 is in a range of 30 wt. % to 60 wt. % with the minerals content shown in Table 4.

TABLE 4

| compound | Wt. % |
|---|---|
| Kaolin | 10-35 |
| Calcium Carbonate (3 μm) | 22-60 |
| Calcium Carbonate (10-13 μm) | 27-60 |
| Calcium Carbonate (30 μm < x < 44 μm) | 0-23 |
| Palygorskite (13 um) | 0.1-8 |
| Na-Montmorillonite (325 Mesh) | 0.1-8 |
| smectite | 0.1-8 |

As another addition, pigment may be added to the coating compound 20, which is essentially pigment less, such as white, off-white, or colorless, at or following mixing in the let-down tank 22. As an example, a mixture 38 with a selected color may be prepared and then added to the coating compound 20. By way of example, the color mixture 38 may be added to the coating compound 20 in the let-down tank 22 or prior to or following addition of any sand and prior to packaging at 30. In one exemplary embodiment, the color mixture 38 may include selected compounds from the C-solution 12 and mixture 16 in addition to a pigment. For example, the color mixture 38 may include the following components: acrylic emulsion (e.g., EPS® 2708 identified above), a defoamer, a dispersant, a wetting agent, a modified polyelectrolyte polymer (e.g., HEC with glyoxal coating), pigment, which may be one or more organic and/or inorganic (i.e., oxide) materials. Exemplary oxide materials include TiO2 and Fe2O3 to name two, and water. The following Table 5 includes an exemplary compound of the color mixture 38.

TABLE 5

| Component | Wt. % (wet basis) |
|---|---|
| EPS ® 2708 or another suitable binder | 0-18 |
| Defoamer | 0-0.2 |
| Dispersant | 0-0.5 |
| Wetting Agent | 0-0.5 |
| Modified hydroxyl ethyl cellulose | 0.23-0.65 |
| Pigments (color); | 29.9-37.9 |
| excluding water used in | |
| pigment dispersions | |
| Water | 5-50 |
| Water from pigments are | |
| included in this value. | |

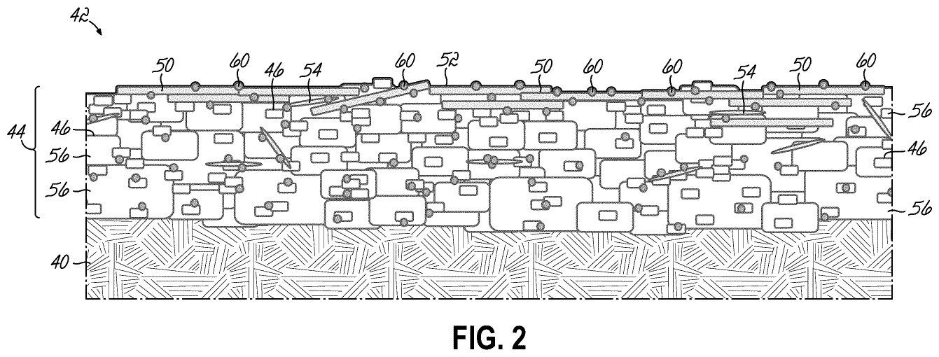

Following mixing, according to the process 10, shown for example in FIG. 1, the coating compound 20 may be mixed with sand, such as 70-100 mesh, prior to application. A coating compound 20 with sand may be advantageous because a single coating application may have greater hiding capability of the base (FIG. 2) to which it is applied than the hiding capability of the coating compound 20 without sand. The particle size distribution of the sand may dictate the thickness of the coating compound when applied. For example, during distribution of the coating compound 20 on a base surface, the squeegee may float over top of the individual sand grains. The minimum coating thickness may therefore be determined by the size of the largest individual grains of sand. As a further example, larger sand grains may produce a thicker coating. Specifically, a 30-70 mesh or a 20-50 mesh sand would generate a thicker applied coating and have higher substrate hiding power although without crack formation in the coating according to one advantage of the coating compound 20.

A biocide, such as 1,2 Benzisothiazolin-3-one (2.5%) and 2-methyl-4-isothiazolin-3-one (2.5%) available from Isomeric Industries, Inc. of Texas under trademark Bionix MBS2525 may be added to one or more of the C-solution 12, mixture 14, and the mixture 16. In an exemplary embodiment, the biocide is added in the let-down tank 22 according to the process 10 of FIG. 1.

Application of the coating compound 20 with or without sand may be achieved by pouring the coating compound 20 from the packaging 30 (e.g., a 5-gallon bucket) onto a surface of a base to be coated. As an example, the base may be concrete or asphalt, although applications are not limited to these specific bases. Following pouring, the coating compound 20 may be distributed across the surface.

With reference to FIG. 2, a technician may utilize a squeegee or similar tool to spread the coating compound 20 on the base 40 to form a layer of the coating compound 20. Drying may occur by evaporation of any liquids, for example, water from the coating compound 20. Following drying, the coating compound 20 transforms into a coating 42.

The exemplary coating 42 is schematically shown in FIG. 2, in which the components of the coating compound 20 are shown. The coating 42 in FIG. 2 is not drawn to scale. It is believed that particulates 44 in the coating compound 20 arrange during application of the coating compound 20 to the base 40 to produce a highly durable aesthetic coating 42 following drying. The particulates 44 from the filler (i.e., in the mixture 14) and from the clay (i.e., in the mixture 16) produce the bulk of the structure of the coating 42. Components from each of the mixtures 14 and 16, when dried, are intended to form a continuous or nearly continuous phase 46 of an acrylic polymer between the particulates 44. By a continuous phase 46, the acrylic polymer is in a solid phase that surrounds the particulates 44 in the bulk of the coating. By nearly continuous phase 46, the acrylic polymer is in a solid phase and surrounds the majority of the particulates 44 in the bulk of the coating with a minority of particulates 44 contacting one another in localized discontinuities (e.g., equal to or less than 10 vol. %) of the solid phase. Alternative or additional latexes include styrenated acrylic and vinyl acrylic polymers. The continuous or nearly continuous phase 46 essentially glues the particulates 44 to one another and to the base 40.

In the exemplary embodiment, the particles 44 have a location preference in the coating 42. The preference may be due to the shape of the particles 44 and/or the application technique used to form the coating 42. In particular, the preference may be due, at least in part, to the particle aspect ratio of the individual particles 44 or the difference in the particle aspect ratio between particles of different compound. It is believed that particles with greater aspect ratios, which are generally more plate-like, have preference for being located at a surface of the coating 42. Segregation of the particles 44 may occur during spreading of the coating compound 20 on the base 40, such as with a tool (e.g., a squeegee).

In that regard, as is shown in FIG. 2, particles of kaolin 50 may be at or near a surface 52 of the coating 42. Similarly, particles of the clay mineral 54, such as palygorskite, may be dispersed in an outer ⅓ of the coating 42. This may be due to their generally larger aspect ratio. Particles of filler 56 may form a bulk of the coating 42 between the base 40 and the layer of particles of kaolin 50. In the exemplary embodiment shown, the particles of filler 56 are from a mixture of three different particle size distributions. Having a mixture of multiple particle size distributions is believed to produce a more efficient packing of particles 44 in the coating 42. Also shown in FIG. 2, are pigment particles 60, which are submicron may be evenly distributed throughout the coating 42 by virtue of electrostatic adherence to larger particles 44. The coating 42 of FIG. 2 illustrates the platy nature of kaolin, the fiber/rod like nature of palygorskite, and the rhombohedral nature of calcium carbonate. With the location preference described (with the kaolin particles 50 forming the surface 52), it is believed that the combination of selected particles 44 provides a smoother coating, even over a porous base, relative to a coating compound without the selected clay mineral and kaolin. Further, it is believed that the small particles, such as the filler particles 56 may electrostatically adhere to the larger particles of each of the filler particles 56, the clay mineral particles 54 and the kaolin particles 50. Both physisorption and chemisorption are expected to occur. For example, carboxylic acid of the acetic acid may chemically bond itself to a surface of a calcium carbonate particle.

In order to facilitate a more complete understanding of the embodiments of the invention, the following non-limiting example is provided.

### Example 1

A coating compound of the following compound of Table 6A was prepared in a multiple stage mixing process.

TABLE 6A

| Component | Wt. % (wet basis) |
|---|---|
| EPS ®2708 | 29.74 |
| Modified hydroxyl ethyl cellulose | 0.84 |
| Kaolin 1-2 μm at 15 m²/g | 4.55 |
| Calcium Carbonate (3 μm) | 5.74 |
| Calcium Carbonate (10-13 μm) | 6.2 |
| Calcium Carbonate (x < 44 μm) | 4.78 |
| Palygorskite | 1.43 |
| C-solution | 5.78 |
| Acetic acid | 0.90 |
| Water | 39.93 |
| Biocide | 0.11 |

To that end, three mixtures in stages were prepared. A C-solution included the components in Table 7A.

TABLE 7A

| Component | Grams |
|---|---|
| Ethylene Glycol | 434.0 |
| Glycol Ether EPH | 378.2 |
| Superwet 9.5 | 99.2 |
| Foam A Tac 220 | 9.3 |
| KemECal 4011 | 62.0 |

The components in Table 7 were combined with mixing as follows. In a 1.5 L stainless steel beaker, the following were combined in the order indicated.
1) Ethylene glycol
2) Glycol Ether EPH
3) Superwet 9.5
4) Foam A tax 220
5) KemECal 4011

The combination was mixed with high agitation using a 4 Hp Fawcett LD-104A mixer with a maximum speed of 3,000 rpm. Mixing conducted between 800-1500 rpm with a disperser blade and without exposing the disperser blade. The mixed solution was transferred to 1 L bottle that was dry. No water was added to the mixture. Once prepared, the C-solution was added to two different mixtures, as follows.

Another mixture included the following components:

TABLE 8A

| Component | Grams |
|---|---|
| EPS ®2708 | 1415 |
| Kaolin 1-2 μm at 15 m²/g | 216.5 |
| Calcium Carbonate (3 μm) | 273 |
| Calcium Carbonate (10-13 μm) | 295 |
| Calcium Carbonate (x < 44 μm) | 227.5 |
| C-solution (Table7) | 225 |
| water | 650 |

The components of Table 8A were mixed with C-solution (Table 7A) using the following procedure.

650 g water and 1415 g of EPS 2708 Latex were added to the same 4 L Fawcett LD mixer after the mixer was cleaned. The water and latex were mixed for 2 minutes with moderate agitation. After 2 minutes, 225 g of C-solution (prepared according to the procedure described above and shown in Table 7A) was added to the water and latex mixture. Following addition, the combined water, latex, and C-solution was mixed with high agitation for 8 min.

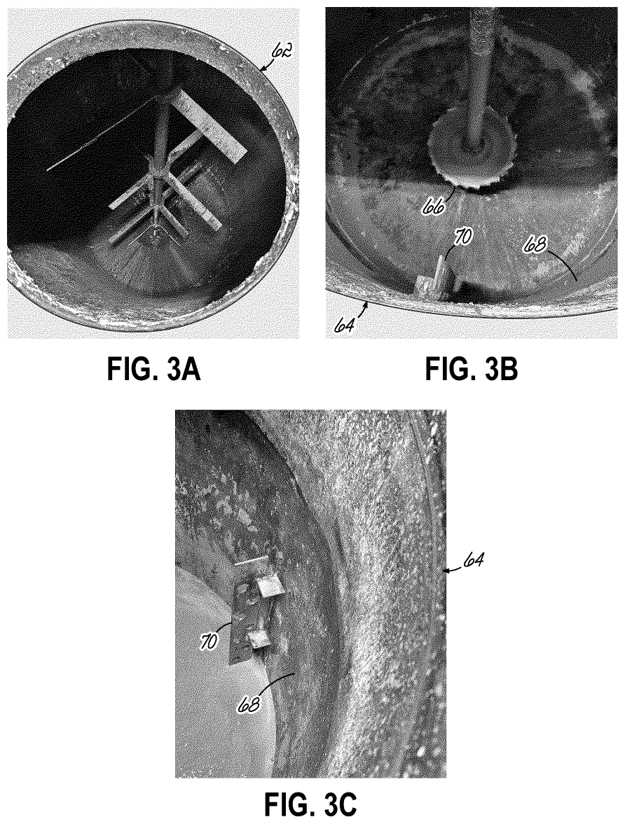

For production quantities of the coating compound, the first and second mixtures may be prepared in the stainless steel dispersion mixer 64, shown for example in FIGS. 3B and 3C in which the dispersion blade 66 and baffle 70 are shown. Note that the mixer 64 includes baffles 70 along an outer wall 68 thereof. The baffles 70 are spaced apart from the outer wall 68 and were installed to promote better mixing, higher shear forces, and to reduce the production time of each grind phase. An exemplary let-down tank 62 is shown in FIG. 3A.

To the combined water, latex, and C-solution mixture, the following minerals were slowly added with moderate agitation in order:
1) 216.5 g of kaolin from Supreme. After addition of the kaolin, the mixture was held for 5 min, by held is meant that the kaolin is metered into the mixer with continuous mixing rather than being dumped into the mixer;
2) 273 g 3 pm calcium carbonate from Lhoist Limestone NF30W. After addition of the Limestone, the mixture was held for 5 min and the mixer speed was increased to adjust for viscosity;
3) 295 g 10-13 pm calcium carbonate from Piqua 70. After addition of the Piqua 70, the mixture was held 5 min. and the mixer speed was increased to adjust for viscosity;
4) 227.5 g (x<44 pm) calcium carbonate from Piqua 300. The addition was by holding for 5 min. Subsequent to the addition, the mixture was mixed for 25 min. The mixture was transferred to a Waring stand mixer in which an additional mixture (described below) was added. The tanks were rinsed between mixtures with water to prevent latex build up and drying. The mixture was mixed with a Waring stand mixer using a flat beater mixing attachment for 120 min. Another mixture included the following components in Table 9A.

TABLE 9A

| Component | Grams |
|---|---|
| Modified hydroxyl ethyl cellulose | 39.81 |
| Palygorskite | 68.25 |
| Acetic acid | 42.8 |
| C-solution (Table 7) | 50 |
| Water | 600 |

To prepare the mixture of Table 9A, 50 g of C-solution (Table 2) were added to 450 g of water and then mixed for 2 min. using a Fawcett dispersion mixer.

After 2 min., 42.8 g of Acetic Acid (used @5 wt. %; prepared from 56 wt. %) was slowly added to the water/C-solution mixture with mild agitation. Then, 68.25 g of Attagel 30-palygorskite was slowly added over 2 min., i.e., held for 2 min. While adding the Attagel 30, clumps were avoided and the addition was made with agitation to the mixture.

After mixing for an additional 10 min. with high shear with a minimum of the vortex created formed to the dispersion blade, 150 g of water (cool or cold water) was added and mixed for 1 to 2 mins. After mixing, the pH of the mixture was checked to ensure that it was in the range of 5.3 to 6.8. Then, 39.81 g of Natrasol 250 HHR was held over 2 min. The mixture was mixed for 10 min. with high shear and a minimum of a vortex to the blade.

The acid-containing mixture was then added to a Waring stand mixer with the latex-containing mixture. The combined mixture was mixed for 120 min.

The temperature of the mixture was measured with an IR gun to ensure the temperature was less than 100° F. When the mixture measured a temperature less than 100° F., 5.1 g of Biocide Bionix MBS2525 was added. After addition of the biocide, the coating compound was mixed for an additional 30 min.

### Example 2

A coating compound of the following compound of Table 6B was prepared in a multiple stage mixing process.

TABLE 6B

| Component | Wt. % (wet basis) |
|---|---|
| RayCryl 61 | 27.33 |
| Modified hydroxyl ethyl cellulose | 0.77 |
| Kaolin 1-2 μm at 15 m²/g | 4.89 |
| Calcium Carbonate (3 μm) | 6.17 |
| Calcium Carbonate (10-13 μm) | 11.80 |
| Palygorskite | 1.28 |
| C-solution | 6.21 |
| Acetic acid | 0.77 |
| Water | 40.66 |
| Biocide | 0.11 |

To that end, three mixtures in stages were prepared. A C-solution included the components in Table 7B.

TABLE 7B

| Component | Grams |
|---|---|
| Ethylene Glycol | 437.2 |
| Glycol Ether EPH | 381.0 |
| Superwet 9.5 | 99.9 |
| Foam A Tac 220 | 9.4 |
| KemECal 4011 | 62.5 |

The components in Table 7B were combined with mixing as follows. In a 1.5 L stainless steel beaker, the following were combined in the order indicated.
1) Ethylene glycol
2) Glycol Ether EPH
3) Superwet 9.5
4) Foam A tax 220
5) KemECal 4011

The combination was mixed with high agitation using a 4 Hp Fawcett LD-104A mixer with a maximum speed of 3,000 rpm. Mixing was conducted at 800-1,500 rpm with a disperser blade and without exposing the disperser blade. The mixed solution was transferred to 1 L bottle that was dry. No water was added to the mixture. Once prepared, the C-solution was added to two different mixtures, as follows.

Another mixture included the following components:

TABLE 8B

| Component | Grams |
|---|---|
| RayCryl 61 | 1210 |
| Kaolin 1-2 μm at 15 m²/g | 216.5 |
| Calcium Carbonate (3 μm) | 273.0 |
| Calcium Carbonate (10-13 μm) | 522.5 |
| C-solution (Table7) | 225 |
| water | 550 |

The components of Table 8B were mixed with C-solution (Table 7B) using the following procedure.

550 g water and 1210 g of RayCryl 61 Latex were added to the same 4 L Fawcett LD mixer after the mixer was cleaned. The water and latex were mixed for 2 minutes with moderate agitation. After 2 minutes, 225 g of C-solution (prepared according to the procedure described above and shown in Table 7B) was added to the water and latex mixture. Following addition, the combined water, latex, and C-solution was mixed with high agitation for 8 min.

For production quantities of the coating compound, the first and second mixtures may be prepared in the stainless steel dispersion mixer 64, shown for example in FIGS. 3B and 3C in which the dispersion blade 66 and baffle 70 are shown. Note that the mixer 64 includes baffles 70 along an outer wall 68 thereof. The baffles 70 are spaced apart from the outer wall 68 and were installed to promote better mixing, higher shear forces, and to reduce the production time of each grind phase. An exemplary let-down tank 62 is shown in FIG. 3A.

To the combined water, latex, and C-solution mixture, the following minerals were slowly added with moderate agitation in order:
1) 216.5 g of Supreme kaolin from Imerys After addition of the kaolin, the mixture was held for 5 min, by held is meant that the kaolin is metered into the mixer with continuous mixing rather than being dumped into the mixer;
2) 273 g 3 pm calcium carbonate from Lhoist Limestone NF30W. After addition of the Limestone, the mixture was held for 5 min and the mixer speed was increased to adjust for viscosity;
3) 522.5 g 10-13 pm calcium carbonate from Piqua 70. After addition of the Piqua 70, the mixture was held 5 min. and the mixer speed was increased to adjust for viscosity; Subsequent to the addition, the mixture was mixed for 25 min. The mixture was transferred to a Waring stand mixer in which an additional mixture (described below) was added. The tanks were rinsed between mixtures with water to prevent latex build up and drying. The mixture was mixed with a Waring stand mixer using a flat beater mixing attachment for 120 min. Another mixture included the following components in Table 9B.

TABLE 9B

| Component | Grams |
|---|---|
| Modified hydroxyl ethyl cellulose | 34.10 |
| Palygorskite | 56.82 |
| Acetic acid | 34 |
| C-solution (Table 7) | 50 |
| Water | 600 |

To prepare the mixture of Table 9B, 50 g of C-solution (Table 2B) were added to 450 g of water and then mixed for 2 min. in the Fawcett dispersion mixer.

After 2 min., 34 g of Acetic Acid (used @5 wt. %; prepared from 56 wt. %) was slowly added to the water/C-solution mixture with mild agitation. Then, 56.82 g of Attagel 30-palygorskite was slowly added over 2 min., i.e., held for 2 min. While adding the Attagel 30, clumps were avoided and the addition was made with agitation to the mixture.

After mixing for an additional 10 min. with high shear with a minimum of the vortex created formed to the dispersion blade, 150 g of water (cool or cold water) was added and mixed for 1 to 2 mins. After mixing, the pH of the mixture was checked to ensure that it was in the range of 5.5 to 6.8. Then, 34.10 g of Natrasol 250 HHR was held over 2 min. The mixture was mixed for 10 min. with high shear and a minimum of a vortex to the blade.

The acid-containing mixture was then added to a Waring mixer with the latex-containing mixture. The combined mixture was mixed for 120 min.

The temperature of the mixture was measured with an IR gun to ensure the temperature was less than 100° F. When the mixture measured a temperature less than 100° F., 5 g of Biocide Bionix MBS2525 was added. After addition of the biocide, the coating compound was mixed for an additional 30 min.

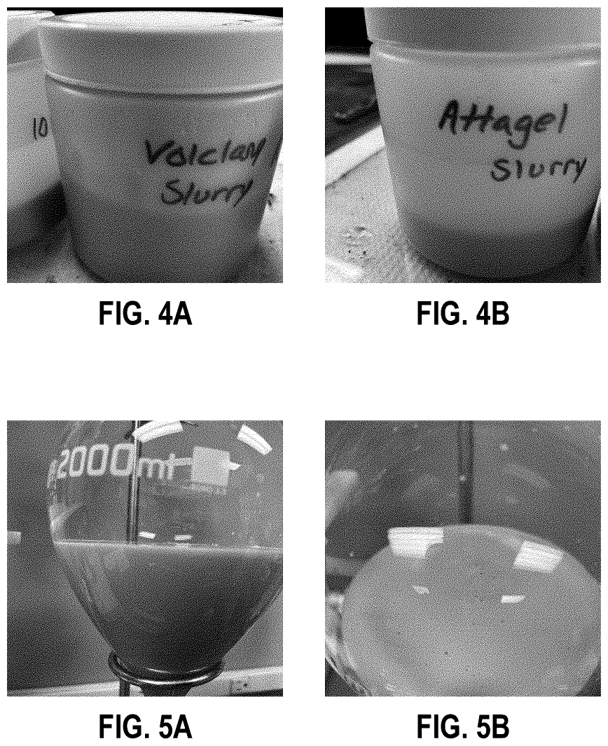

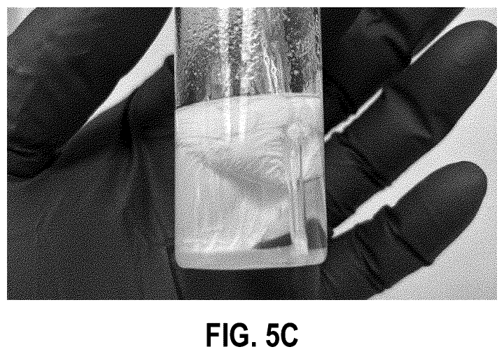

FIG. 4A is a photograph of a montmorillonite slurry without any additions other than water. The particles are dispersed. FIG. 4B is a photograph of a palygorskite slurry prior to the addition of other compounds showing that the particles segregate in water. FIGS. 5A and 5B are photographs after addition of ethylene glycol, glycol ether EPH, defoamer, KemECal 4011, and nonylphenol ethoxylate showing that the particles stay dispersed in solution after 2 to 4 weeks without subsequent mixing.

FIG. 5C is an example of mixing an acrylic latex directly with glycol ether EPH in which the compounds coagulate. Coagulation prematurely consumes compounds making their addition wasteful, problematic, and may cause visual quality issues. Embodiments of the invention avoid coagulation.

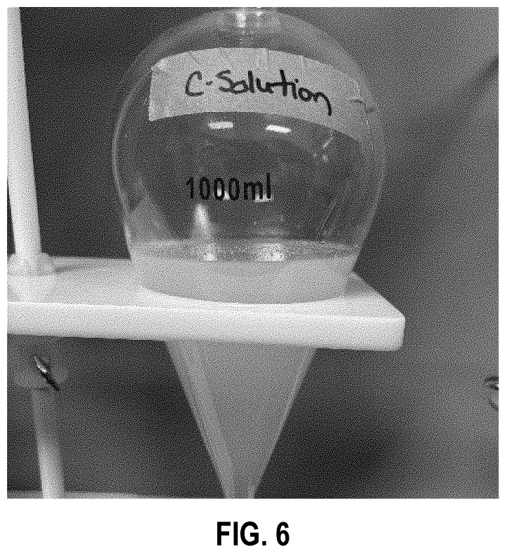

FIG. 6 is an image of the C-solution of Table 7A prepared according to the procedure above.

### Application Photos and Results (Durability)

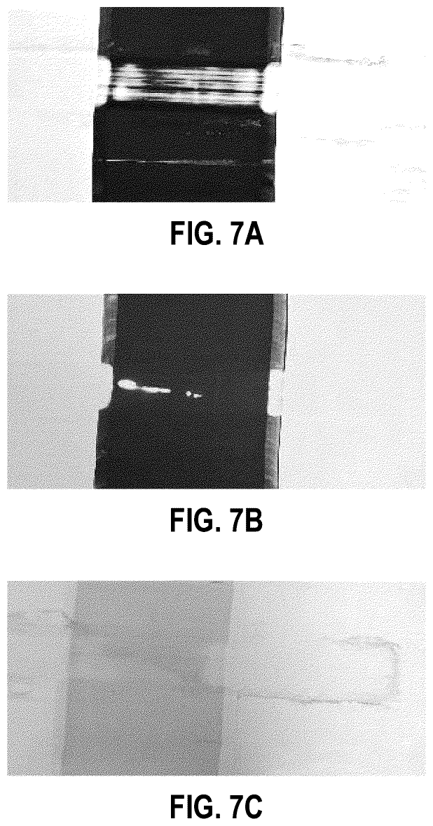

With reference to FIGS. 7B and 7C, the coating compound of Table 6A, prepared according to the procedure in this example was spread on a substrate to a thickness of 20 mil. Each of the samples of FIGS. 7B and 7C (which differs by color only) were subject to a scrub test with a predetermined number of abrasive passes with a brass brush. The test was designed to measure durability similar to ASTM D2486-17. In FIG. 7A, a competitive coating is shown in which it is believed that one filler is silica, such as fumed silica. As shown by way of comparison, the coatings of FIGS. 7B and 7C are more durable than the competitive coating of FIG. 7A.

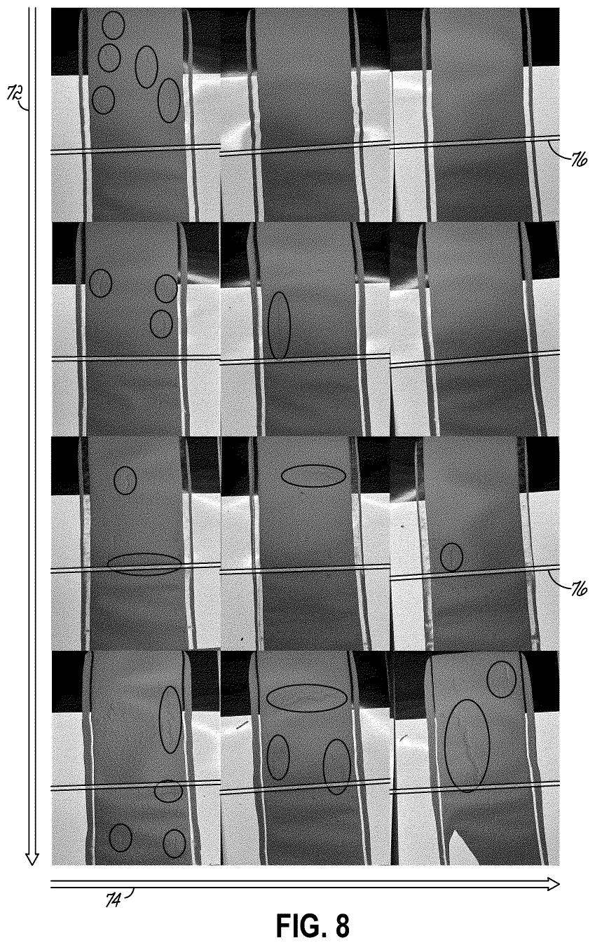

In FIG. 8, there is a collage of sample coatings. According to the collage, a particle size distribution of the filler was investigated for cracking of the coating when dried. In this example, only the particle size distribution is modified. Coatings were applied at 60° C. Along the arrow 72 (left side), a thickness of the coating on the substrate is increasing. The thickness at each row is 40 mil (top), 50 mil, 60 mil, and 70 mil (bottom). Thus, the coatings in the bottom row are thickest. According to arrow 74, the particle size distribution is changing from less favorable (left) to more favorable (right). The line 76 in each sample divides glossy substrate (paper) on top from flat substrate (bottom). It is believed that a coating on a glossy substrate is more likely to crack. Cracks are circled.

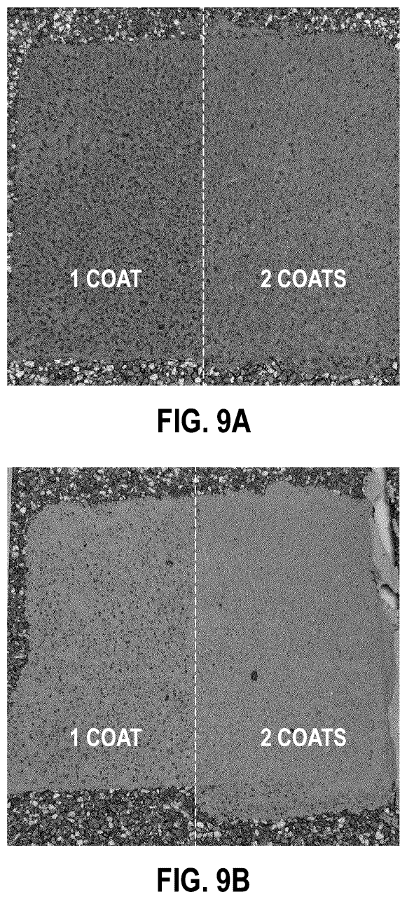

In FIGS. 9A and 9B, another comparison of coatings is shown with FIG. 9A depicting a coating from a coating compound without kaolin and FIG. 9B depicting a coating from a coating compound with kaolin. The coating of FIG. 9B is smoother than the coating of FIG. 9A. Generally, in FIG. 9A, the 1-coat coating had lots of holes and the 2-coat coating had some holes. In FIG. 9B, the 1-coat coating had some holes and the 2-coat coating was smooth (very few holes).

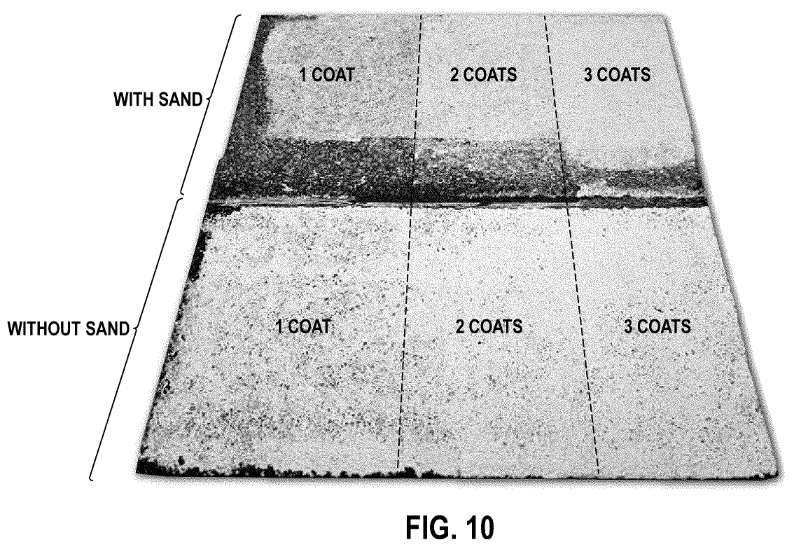

In FIG. 10, coatings with (top) and without (bottom) and added to the coating compound are shown. It was observed that that coatings with sand have a greater capability to hide the substrate. In this application, the substrate is asphalt roof shingles. The roughness of the shingle surfaces was smoothed as the coating compound filled the voids.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method and illustrative examples shown and described. Accordingly, departures may be made from such details without departing from the scope of the general inventive concept.

What is claimed is:

1. A coating compound for application on a base surface for use as a sport surface, the coating compound comprising:
a mixture of:
a liquid vehicle comprising water, a latex, and glycol ether EPH; and
particles of kaolin.

2. The coating compound of claim 1 wherein the liquid vehicle further comprises:
an organic acid.

3. The coating compound of claim 2 wherein the organic acid includes acetic acid.

4. The coating compound of claim 1 further comprising:
a clay mineral.

5. The coating compound of claim 4 wherein the clay mineral includes one clay mineral or a combination of two or more clay minerals selected from palygorskite, montmorillonite, and smectite.

6. The coating compound of claim 5 wherein the clay mineral is palygorskite.

7. The coating compound of claim 1 wherein all nonaqueous components of the coating compound are present in an amount from 30 wt. % to 60 wt. %.

8. The coating compound of claim 1 wherein the coating compound further comprises:
particles of calcium carbonate.

9. A process for manufacturing a coating compound for application to a base surface, the process comprising:
mixing at least a portion of a liquid vehicle, including glycol ether EPH, in a first mixture;
mixing a second mixture including particles of kaolin, latex, and a portion of the first mixture;
mixing a third mixture including particles of a clay mineral in a liquid vehicle; and
mixing the second mixture with the third mixture whereby the coating compound is formed.

10. The process of manufacturing of claim 9 wherein mixing the third mixture includes mixing another portion of the first mixture.

11. The process of manufacturing of claim 9 wherein mixing the at least a portion of the liquid vehicle of the first mixture includes adding ethylene glycol.

12. The process of manufacturing of claim 9 wherein mixing the third mixture includes mixing an organic acid.

13. The process of manufacturing of claim 12 wherein mixing the organic acid includes mixing acetic acid.

14. The process of manufacturing of claim 9 wherein mixing the third mixture includes mixing includes mixing one clay mineral or a combination of two or more clay minerals selected from palygorskite, montmorillonite, and smectite.

15. The process of manufacturing of claim 9 wherein mixing the third mixture includes mixing palygorskite.

16. The process of manufacturing of claim 9 wherein mixing the second mixture includes mixing particles of calcium carbonate.

17. The process of manufacturing claim 9 wherein nonaqueous components of the coating compound are present in an amount from 30 wt. % to 60 wt. % of the coating compound.

18. A coating on a base on which a sport is to be played, the coating comprising:
a plurality of particles including particles of kaolin and at least one other particle; and
a continuous or nearly continuous phase between adjacent particles in which the continuous or nearly continuous phase includes an acrylic polymer.

19. The coating of claim 18 wherein the at least one other particle is a clay mineral.

20. The coating of claim 19 wherein the clay mineral includes one clay mineral or a combination of two or more clay minerals selected from palygorskite, montmorillonite, and smectite.

21. The coating of claim 18 wherein the continuous phase or nearly continuous phase including the acrylic polymer further includes acetic acid.
